(19) United States
(12) Patent Application Publication
(10) Pub. No.: US 2012/0260506 A1
(43) Pub. Date: Oct. 18, 2012

(54) HAND TOOL FOR SEPARATING THE MEAT OF PRODUCE FROM THE SKIN, RIND OR SHELL

(76) Inventor: Kevin Kimsey, Prescott, AZ (US)

(21) Appl. No.: 13/438,640

(22) Filed: Apr. 3, 2012

Related U.S. Application Data
(60) Provisional application No. 61/474,450, filed on Apr. 12, 2011.

(51) Int. Cl. A47J 43/28; B26B 27/00

(52) U.S. Cl. 30/278

(57) ABSTRACT

This is directed to systems, processes, machines, and other means that enable a user to remove meat from produce. The invention can provide users with a malleable wire that can be attached to a handle to remove the meat from an avocado, mango or kiwi.

### CROSS REFERENCE TO RELATED APPLICATIONS

This application claims priority to U.S. Provisional Patent Application number 61/474,450 filed on Apr. 12, 2011.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY REFERENCE OF MATERIAL SUBMITTED ON A COMPACT DISC

Not Applicable

### FIELD OF THE INVENTION

This invention relates to tools used to cut produce in particular avocados and mangos.

### BACKGROUND OF THE INVENTION

Traditional straight blade knives take a remarkable amount of time to cut avocadoes and mangos inefficiently. The claimed invention resolves that difficulty by providing a unique cutting wire instead of a traditional blade.

### BRIEF SUMMARY OF THE INVENTION

The present invention includes methods, systems, and other means for A hand tool for removing meat from produce, comprising a handle, having an egg shape, further comprising a first hole and a second hole. There is a wire loop immediately adjacent to the first hole and second hole. The wire loop is malleable and can be easily manipulated by hand.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of the invention shown in use.

FIG. 2 is a perspective view of the invention.

FIG. 3 is a section view of the invention taken along line 3-3 in FIG. 2.

FIG. 4 is a perspective view of an alternate embodiment of the invention.

FIG. 5 is a section view of the alternate embodiment of the invention taken along line 5-5 in FIG. 4.

FIG. 6 is a section view of the alternate embodiment of the invention showing the adjustable size wire loop reduced in diameter.

### DETAILED DESCRIPTION OF THE INVENTION

Embodiments of the present invention overcome many of the obstacles associated with separating the meat of produce from the skin, rind or shell, and now will be described more fully hereinafter with reference to the accompanying drawings that show some, but not all embodiments of the claimed inventions. Indeed, the invention may be embodied in many different forms and should not be construed as limited to the embodiments set forth herein. Rather, these embodiments are provided so that this disclosure will satisfy applicable legal requirements. Like numbers refer to like elements throughout.

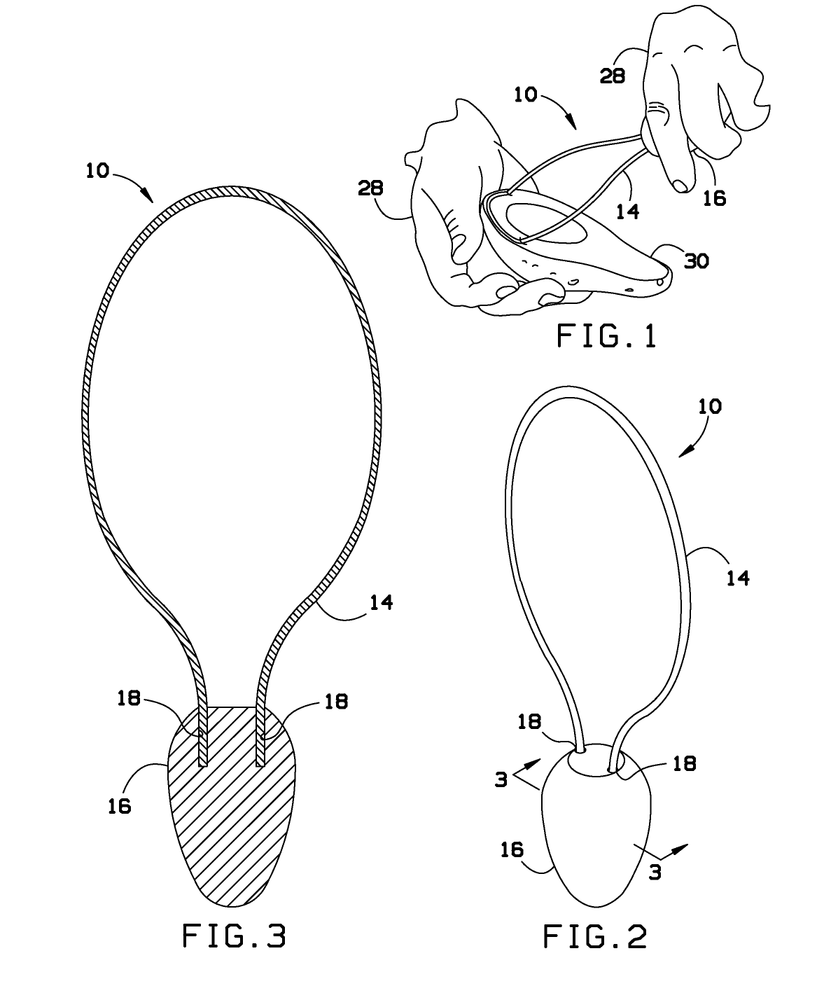

FIG. 1 shows the invention in use a user has a first hand 28, a second hand 28, and desires to remove the meat from produce, shown here as avocado 30, with hand tool 10. The user can do this by holding handle 16 in first hand 28, holding avocado 30 in second hand 28 and scooping the meat from avocado 30 with wire loop 14.

After slicing avocado 30 into halves, the user should hold one half in the palm of first hand 28 wide end up. The user can then hold wire loop 14 up to the avocado half. Using the thumb and forefinger of second hand 28 the user should squeeze wire loop 14 together until it is the shape of the half of avocado 30. The user can then place the top of wire loop 14 at the top of avocado 30 between the meat and the skin. With a gentle scooping motion the user should slide the wire loop 14 along the contour of the skin separating the skin from the meat. The meat of avocado 30 can be left in the skin shell with the seed to retain its freshness if it is not fully used.

FIG. 2 shows a perspective view of the invention. As noted above hand tool 10 comprises handle 16 mechanically coupled to wire loop 14 at first hole 18 and second hole 18. The shape of the handle is preferably the shape of an egg but can take any other shape such as round or oval. The egg shape is designed to fit comfortably in the palm. The material for the handle can be but not limited to wood, plastic, metal or any other suitable material.

FIG. 3 shows a section view of hand tool 10. Handle 16 comprises first hole 18 and second hole 18. To make the device a manufacturer mechanically couples wire loop 14 into first hole 18 and second hole 18. As shown here, wire loop 14 terminates and is permanently fixed in handle 16.

Wire loop 14 can be formed from any wire but preferably, but not limited to a tempered stainless steel wire as long is wire loop 14 has sufficient tensile strength to scoop the meat of produce from the skin rind or shell. The length of the wire is approximately (but not necessarily) between 4-18 inches long. Handle 16 is preferably (but not necessarily) between 1-5 inches long and is more preferably about 2 inches in length and approximately (but not necessarily) between 1-3 inches wide but more preferably 1½ inch wide. Wire loop 14 is mechanically coupled to handle 16 using any known fasteners such as epoxy, adhesives, screws and/or bolts. Wire loop 14 can be mechanically coupled to the handle by inserting each end into two holes located in the top of the handle and then held in place by epoxy, adhesives, screws and/or bolts.

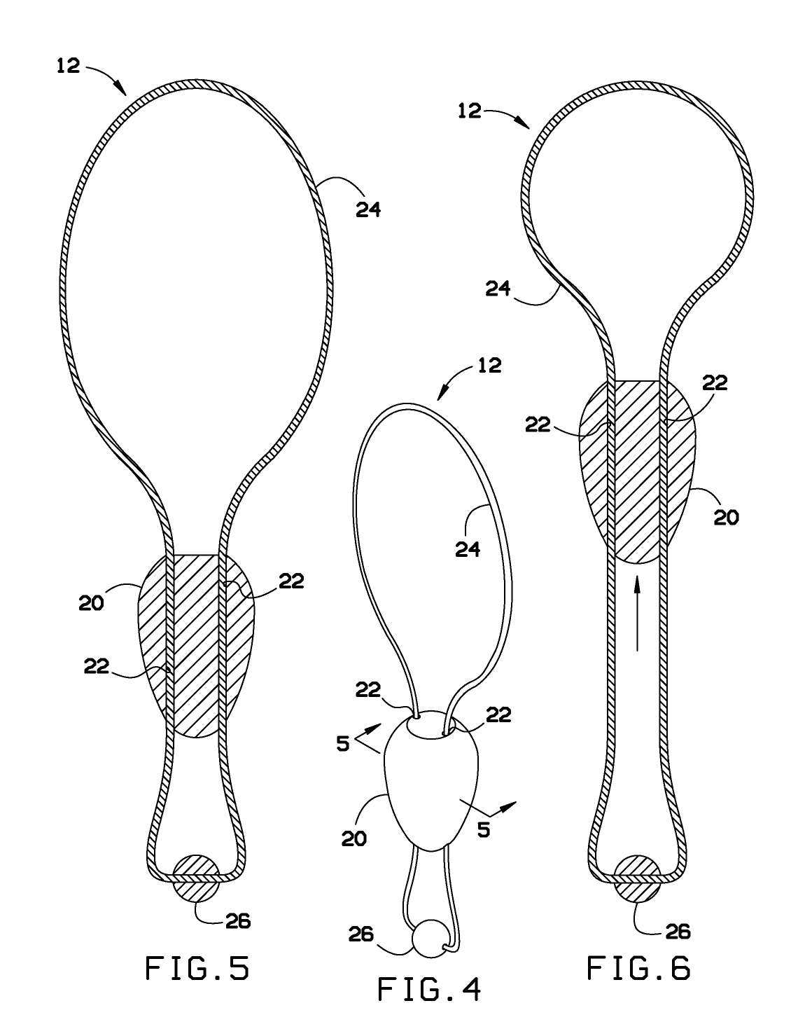

FIG. 4 shows alternate hand tool 12. Alternate hand tool 12 comprises handle 20, which further comprises first hole 22 and second hole 22. Wire loop 22 travels through handle 20 and is immediately adjacent to handle 20, but wire 22 is not mechanically coupled to handle 20. Wire loop 22 is immediately adjacent to but not mechanically coupled to adjustment knob 26. Similar to wire loop 14, wire loop 24 can be formed from any wire but preferably, but not limited to a tempered stainless steel wire. The length of the wire is approximately (but not necessarily) between 4-24 inches long.

FIG. 5 shows a section view of alternate hand tool 12. As noted above, handle 20 comprises first hole 22 and second hole 22 which both run the length of handle 22. Handle 16 is preferably (but not necessarily) between 1-5 inches long and is more preferably about 2 inches in length and approximately (but not necessarily) between 1-3 inches wide but more preferably 1½ inch wide.

FIG. 6 shows a section view of alternate handle tool 12. A user can hold adjustment knob 26 and slide handle 20 as shown adjust the wire loop diameter and to peel and clean various fruits and vegetables such as kiwis, melons, mangos, peppers and avocados.

That which is claimed:

1. A hand tool for removing meat from produce, comprising
a handle, having an egg shape, further comprising a first hole and a second hole;
a wire loop immediately adjacent to the first hole and the second hole; and
where the wire loop is malleable and can be easily manipulated by hand.

2. The hand tool of claim 1 further comprising,
the wire loop mechanically coupled to the first hole and the second hole.

3. The hand tool of claim 1 further comprising,
the wire loop mechanically coupled to the first hole and the second hole by an epoxy; and
where the wire loop is made from stainless steel.

4. The hand tool of claim 1 further comprising,
the wire loop mechanically coupled to the first hole and the second hole by adhesives; and
where the wire loop is made from stainless steel.

5. The hand tool of claim 1 further comprising,
the wire loop mechanically coupled to the first hole and the second hole by adhesives;
where the wire loop is made from stainless steel;
where the wire loop has sufficient tensile strength to scoop meat from avocados.

6. The hand tool of claim 1 further comprising,
where the first hole is a length of the handle and the second hole is the length of the handle; and
where the wire loop is immediately adjacent to an adjustment knob.

7. The hand tool of claim 1 further comprising,
where the first hole is a length of the handle and the second hole is the length of the handle;
where the wire loop is immediately adjacent to an adjustment knob;
where the wire loop has sufficient tensile strength to scoop meat from mangos; and
where a user can use the adjustment knob to adjust a wire loop diameter.
